(19) United States
(12) Patent Application Publication
(10) Pub. No.: US 2015/0169891 A1
(43) Pub. Date: Jun. 18, 2015

(54) SYSTEMS, METHODS, AND APPARATUS FOR PROVIDING CONTENT TO RELATED COMPUTE DEVICES BASED ON OBFUSCATED LOCATION DATA

(71) Applicant: DSTILLERY, INC., New York, NY (US)

(72) Inventors: Rodney HOOK, New York, NY (US); Brian DALESSANDRO, Brooklyn, NY (US); Kevin REILLY, Rockville Centre, NY (US)

(73) Assignee: DSTILLERY, INC., New York, NY (US)

(21) Appl. No.: 14/572,418

(22) Filed: Dec. 16, 2014

Related U.S. Application Data
(60) Provisional application No. 61/916,587, filed on Dec. 16, 2013.

(51) Int. Cl. G06F 21/62; G06F 17/30; G06Q 30/02

(52) U.S. Cl. CPC G06F 21/6218; G06Q 30/0257; G06F 17/30345

(57) ABSTRACT

Some embodiments described herein relate to receiving obfuscated location data associated with a first compute device, such as a mobile phone. A database including records of multiple compute devices, including a second compute device, associated with multiple obfuscated locations can be accessed and a link between the first compute device and the second compute device can be defined based, at least in part on the obfuscated location data associated with the first compute device matching a record for the second compute device. In some embodiments, the first compute device and/or the second compute device can receive content based, at least in part on the link.

### CROSS REFERENCE TO RELATED APPLICATIONS

This application claims priority under 35 U.S.C. §119(e) to Provisional U.S. Patent Application No. 61/916,587, filed Dec. 16, 2013, entitled “Systems and Methods for Collecting and Using Mobile Geo-Location Data for Relevant Ad Targeting,” the disclosure of which is incorporated herein by reference in its entirety.

This application is related to U.S. patent application Ser. No. 13/492,569, filed Jun. 8, 2012, entitled “Privacy Sensitive Methods, Systems, and Media for Geo-Social Targeting,” the disclosure of which is incorporated herein by reference in its entirety.

### BACKGROUND

Some embodiments described herein relate generally to systems, methods, and apparatus for providing content to related compute devices based on location data while preserving user privacy. For example, some embodiments relate to determining that multiple compute devices are related based on obfuscated or hashed location data.

Recently, a demand for content and advertisements that are targeted to users based on their location and/or their location history has arisen. Known geo-targeted advertisements typically trigger events based on the user crossing a geo-fence, rely on obtaining and/or retaining raw location data such as latitude and longitude data, or otherwise collect sensitive personal data. These known approaches raise substantial privacy concerns, and content providers, application developers, device manufacturers, and internet service providers have taken steps to assure their customers that their privacy is being respected. For example, some mobile browsers do not allow content providers to store cookies and some internet service providers (“ISPs”) and/or advertising exchanges will not pass location data onto advertisers.

Simultaneously, users are increasingly using multiple computing devices, such as a mobile communication device, a home personal computer, a work personal computer, etc. to consume content. A need therefore exists to determine that relationships exist between multiple communication devices. Determining that such relationships exist could allow content providers and advertisers to provide customized experiences on one device based on the user's browsing and/or traveling activity with another device. Privacy concerns render known data analysis techniques unsatisfactory for determining these relationships. For example, when location information is not available due privacy policies, difficulties can exist in determining that two devices are associated with each other (e.g., possessed, accessed, or controlled by the same user). A need therefore exists for systems, methods, and apparatus that can define associations between multiple devices based on location data while respecting user privacy.

### BRIEF DESCRIPTION OF THE DRAWINGS

FIG. 1 is a schematic illustration of a system for associating multiple compute devices, according to an embodiment.

FIG. 2 is a schematic illustration depicting a polygon method for determining a device location, according to an embodiment.

FIG. 3 is a method of collecting, obfuscating, and storing geo location data, according to an embodiment.

FIG. 4 is a method of defining an association between two compute devices based on obfuscated location data, according to an embodiment.

FIG. 5 is an illustration of location-based brand affinity, according to an embodiment.

FIGS. 6-8, 9A, and 9B are each an illustration of an instance of brandscaping.

### DETAILED DESCRIPTION

Some embodiments described herein relate to receiving location data associated with a first compute device, such as a mobile phone. The location data can, for example, represent one or more geographic places visited by a user carrying the first compute device. In some embodiments, raw location data can be received. For example, the location data can include latitude and longitude (“lat-long”) coordinates suitable for identifying a location and/or such that the one or more geographic place associated with the location data can be identified. Such location data can be obfuscated, for example by applying a one-way hash, to produce obfuscated location data (also referred to herein as “hashed location data”). Obfuscating the location data can ameliorate data privacy issues that may be associated with processing and storing location data. In some embodiments, the data in the form in which they was originally received may be deleted or otherwise not retained after the obfuscation. The obfuscated location data can be uniquely associated with a location such that if the user carrying the first compute device visits a geographic place multiple times, the process of obfuscating the location data can return the same obfuscated location data each time. The geographic place associated with the obfuscated location data, however, may not be decipherable based solely on the obfuscated location data. That is, the geographical context may be removed such that the obfuscated location data may not be locatable on a map and distances or directions between obfuscated location data may not be determinable. The obfuscated location data can be compared against a database of obfuscated identifiers. A link between the first compute device and a second compute device can be defined based on the obfuscated location data matching an entry in the database of obfuscated identifiers indicating that the second compute device had been at a location associated with the obfuscated location data. In some embodiments, the first compute device and/or the second compute device can receive content based, at least in part, on the link.

Some embodiments described herein relate to receiving obfuscated location data associated with a first compute device, such as a mobile phone. The obfuscated location data can be uniquely associated with a given location such that if the user carrying the first compute device visits a geographic place multiple times, the same obfuscated location data may be received for each visit. The geographic place associated with the obfuscated location data, however, may not be decipherable based solely on the obfuscated location data. A database including records of multiple compute devices, including a second compute device, associated with multiple obfuscated locations can be accessed and a link between the first compute device and the second compute device can be defined based, at least in part on the obfuscated location data associated with the first compute device matching a record for the second compute device. In some embodiments, the first compute device and/or the second compute device can receive content based, at least in part on the link.

Some embodiments described herein relate to defining a link between a first compute device and a second compute device based on a pattern of location data associated with the first compute device corresponding to a pattern of location data associated with the second compute device. Data representing a location of the first compute device can be received and compared to a database containing multiple records of obfuscated locations associated with a brand, and a match between the first compute device and an obfuscated location associated with the brand can be defined. A score for the brand can be calculated for a location associated with the second compute device based, at least in part, on (1) the match between the location of the first compute device and the obfuscated location and/or (2) the link between the first compute device and the second compute device. Similarly stated, the score for the location associated with the second compute device can be influenced by (1) the first compute device matching a hash of the location associated with the brand and/or (2) the first compute device being matched to the second compute device.

Some embodiments described herein relate to “Geo-Relevance,” which can refer to location based analysis. Some embodiments described herein relate to a data store (e.g., a database) of location indicators, such as indicators representing individual latitude and longitude coordinates, polygon coordinates, the context of the locations, etc. Location context can include location name (Starbucks®, Central Park, St. Patrick Cathedral), location type (electronics store, church, park, veterinarian), statistical designation (urban, suburban, rural), etc. Location context can be determined using a variety of approaches, including querying third-party point-of-interest information.

Some embodiments described herein relate to a “Geo-History” store, which can be a data store of indicators of locations visited by a user (e.g., lat-long coordinates and/or any other suitable location information or location proxy, such as cellular tower identifier, IP address, etc.). In some embodiments, the Geo-History store can exclude personally-identifiable information. For example, a user may be identified by an anonymous device identifier (“deviceID”) and/or a hashed identifier of the Geo-Relevant location (“locationID”). Similarly stated, in some embodiments, the Geo-History store may not include literal (e.g., unobfuscated) latitude and longitude coordinates and/or literal (e.g., unobfuscated) deviceIDs. In this way, user privacy can be produced, maintained, or enhanced. In other embodiments, the Geo-History store can include personally-identifiable information and/or a literal (e.g., unobfuscated) location identifier.

Some embodiments described herein relate to a “Commercial Action,” which can be a store visit, purchase, and/or any other suitable action a marketer may desire the user to take. A Commercial Action data store can include locationIDs associated with Commercial Actions. For example, a locationID associated with a Starbucks® location can be stored in a Commercial Action data store. In this way, if the user visits that Starbucks® location, makes a purchase at the Starbucks® location, or takes any other suitable Starbucks® Commercial Action, a locationID of his or her Geo-History can match a locationID in the Commercial Action data store. Such a match can indicate that the Commercial Action has occurred, and a “Commercial Action Identifier” associated with the Commercial Action can be defined to identify the Commercial Action and/or the type of Commercial Action (e.g., store visit, purchase, etc.). Furthermore, in some embodiments, location data, such as GPS data, IP address, etc., can be associated with the Commercial action, such that the Commercial Action Identifier can be operable to associate the Commercial Action with a location.

Some embodiments described herein relate to a “User Commercial Action History” data store, which can include or store an anonymous deviceID, a Commercial Action Identifier, an identifier associated with the marketer with whom the Commercial Action Identifier is associated, and/or any other suitable data. In some embodiments, the User Commercial Action History data store can include an identifier that personally identifies the user.

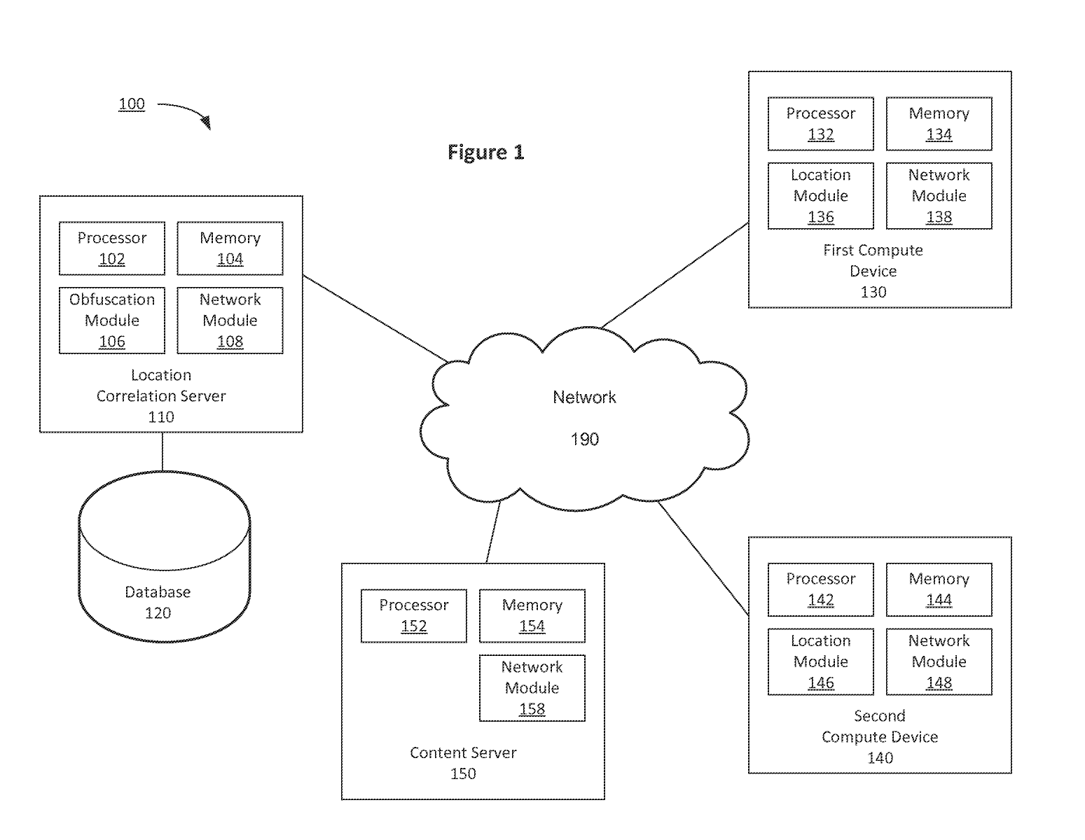

FIG. 1 is a schematic illustration of a system 100 including a first compute device 130, a second compute device 140, a location correlation server 110, and a content server 150, communicatively coupled via a network 190. The first compute device 130 and the second compute device 140 can each be a personal computer, a tablet computer, a personal digital assistant (PDA), a cellular telephone, a television, a set-top box, a portable/mobile internet device, digital out of home devices (e.g., digital billboards, automobile infotainment systems, in-taxi information devices, etc.), and/or any other suitable computing entity. The network 190 can be any communication network or combination of networks capable of transmitting information (e.g., data and/or signals) and can include, for example, the Internet, an intranet, a telephone network, an Ethernet network, a fiber-optic network, a wireless network, and/or a cellular network.

In some embodiments, the first compute device 130 can be a mobile compute device, such as a smartphone. The first compute device 130 includes a processor 132, a memory 134, a location module 136, and a network module 138. The processor 132 can be, for example, a general purpose processor, a Field Programmable Gate Array (FPGA), an Application Specific Integrated Circuit (ASIC), a Digital Signal Processor (DSP), and/or the like. The processor 132 can be configured to retrieve data from and/or write data to memory, e.g., the memory 134, which can be, for example, random access memory (RAM), memory buffers, hard drives, databases, erasable programmable read only memory (EPROMs), electrically erasable programmable read only memory (EEPROMs), read only memory (ROM), flash memory, hard disks, floppy disks, cloud storage, and/or so forth. The network module 138 can be a wired and/or wireless transmission module operable to communicatively couple the first compute device 130 to the network 190. For example, the network module 138 can be a wired and/or wireless network interface controller (NIC), a cellular telephone module, a Bluetooth® module, a ZigBee® module, ultrasonic, magnetic and/or any other suitable module configured to send and/or receive signals via the network 190. The location module 136 can be a GPS module or any other suitable hardware and/or software (e.g., executing on a processor) module operable to determine the location of the first compute device 130.

In some embodiments, the second compute device 140 can be associated with first compute device 130 in a manner that is useful to content providers and/or advertisers. For example, the first compute device 130 and the second compute device 140 can be owned by the same user, shared by users in the same household, shared by users with similar demographic, lifestyle, traveling, and/or content consumption patterns, etc. In some instances, the first compute device 130 can be a user's smartphone and the second compute device 140 can be that same user's home and/or work personal computer. The second compute device 140 includes a processor 142, a memory 144, a location module 146, and a network module 148, each of which can be structurally and/or functionally similar to the processor 132, the memory 134, the location module 136 and/or the network module 138, respectively.

The first compute device 130 and/or the second compute device 140 can be operable to access content and/or be served advertisements via the network 190 (e.g., the Internet). The content server 150 can be operable to send content and/or advertisements to the first compute device 130 and/or the second compute device 140 via the network 190. The content server 150 includes a processor 152, a memory 154, and a network module 158, which may be structurally and/or functionally similar to the processor 132, the memory 134, and/or the network module 138, respectively.

As described in further detail herein, the user of the first compute device 130, the user of the second compute device 140, and/or the operator of the content server 150 may desire that tailored content and/or advertisements be provided to the first compute device 130 and/or the second compute device 140. Such tailored content and/or advertisements may be based on the location data associated with one or both of the first compute device 130 and second compute device 140, data indicating a relationship between the first compute device 130 and the second compute device 140, and/or data indicating that the user of the first compute device 130 and/or the second compute device 140 has engaged in a Commercial Action associated with a brand. In some embodiments, data privacy concerns, policies, and/or regulations, however, may present difficulties in the content server 150 obtaining and/or receiving location data. Accordingly, in some embodiments, an intermediate device such as the location correlation server 110 can be operable to handle location data, anonymize location data, define and store links between compute devices based, at least in part, on location data, etc. The location correlation server 110 can be communicatively coupled to a database 120, which can store location records, records of associations between compute devices, and/or any other suitable data. In addition or alternatively, such data can be stored in a memory 104.

The location correlation server 110 includes a processor 102, the memory 104, an obfuscation module 106, and a network module 108. The processor 102, the memory 104, and the network module 108 can be structurally and/or functionally similar to the processor 132, the memory 134, and/or the network module 138, respectively. The location correlation server 110 can be, for example, one or more compute devices associated with an advertising exchange server, an analytics provider, a content provider, an internet service provider, and/or any other suitable intermediary “in the cloud” between the first compute device 130 and/or the second compute device 140 and the content server 150. Although shown separately, in some embodiments, the location correlation server 120 and the content server 150 can be a single physical and/or logical computing entity.

The first compute device 130 and/or the second compute device 140 can be operable to execute a location-aware application (“app”) and/or access a location-aware website (e.g., an application or website operable to obtain location data associated with the compute device) such that the app or website can transmit location data (e.g., obtained via the location module(s) 136, 146) to the location correlation server 110. In some instances where the location-aware app and/or website does not or cannot access data from the location module(s) 136, 146 (or in alternative embodiments where the first compute device 130 and/or the second compute device 140 does not include a location module), the location correlation server 110 can obtain any suitable information correlated with location, such as IP address, cell tower data, signal strength data, etc. for that compute device. In some instances, the location correlation server 110 can also receive, for example: 1) a unique identifier for the first compute device 130 and/or the second compute device 140 (e.g., deviceID, Apple's® identifier for advertisers “IDFA,” Android® ID, etc.), 2) an application identifier (“appId”) associated with the application that facilitates the data transmission, 3) a uniform resource locator (“URL”) associated with the website causing the data transmission to occur, and so forth.

When the first compute device 130 and/or the second compute device 140 accesses an app or website operable to display advertising (an “ad-capable” app or website), the app or website can transmit a bid request to the location correlation server 110, which can be associated with an advertising exchange (not shown). The associated data sent by the first compute device 130 and/or the second compute device 140 can be used, at least in part, by the content server 150 and/or the advertising exchange to select relevant advertisements. As described in further detail herein, in some embodiments, the associated data sent by the first compute device 130 and/or the second compute device 140 can be used to associate an identifier sent by the first compute device 130 and/or the second compute device 140 with an anonymous user such that previously-collected information associated with that anonymous user can be used to select relevant advertisements. Once selected, the advertisement (data configured to cause display of an advertisement) can be delivered from the location correlation server 110 and/or the content server 150 to the first compute device 130 and/or the second compute device 140.

In some embodiments, as described in further detail herein, the location correlation server 110 can assign an anonymous identifier to the first compute device 130 and/or second compute device 140, hash location data, and take other suitable steps such that stored data and/or data passed to other computing entities (such as an advertising exchange, the content server 150, etc.) are unable to uniquely identify the user based solely on the data. In some embodiments, anonymous identifiers can be, for example, a hash of one or more of a locationID of the compute device(s) 130, 140, auxiliary geo location data, marketer data, and/or any other suitable data.

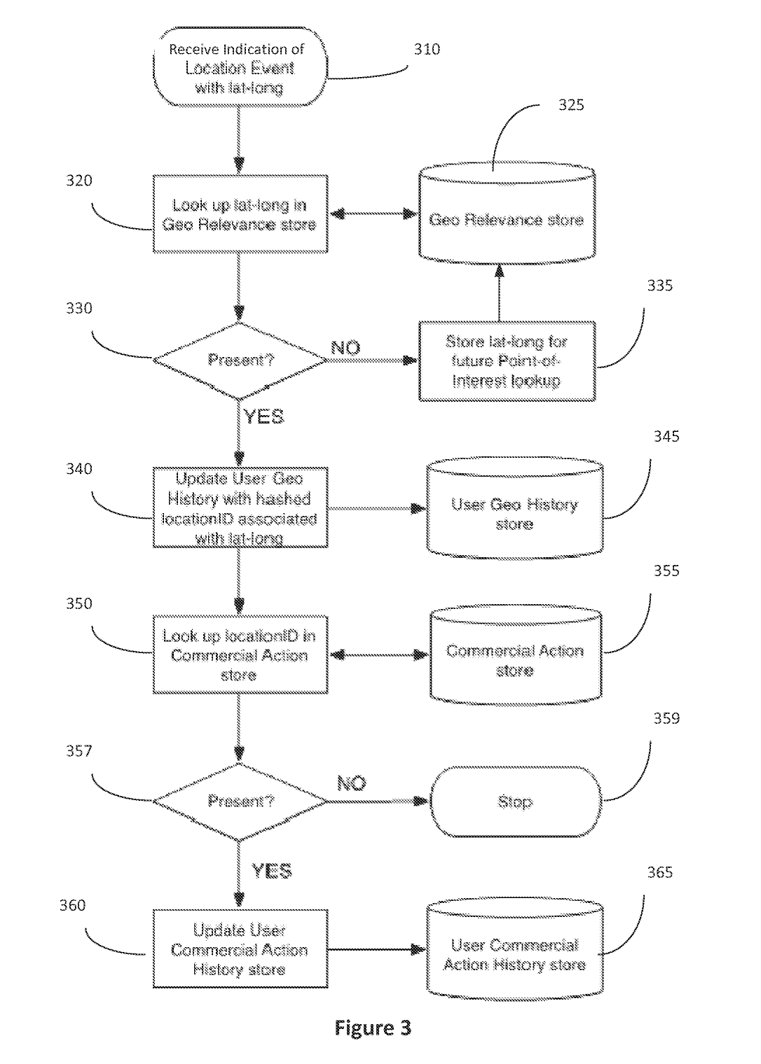

FIG. 3 depicts a process for the collection, hashing and storing of geo location data, according to an embodiment. The process depicted in FIG. 3 can, in some embodiments, be executed by the location correlation server 110 (e.g., on the processor 102) and/or embodied as instructions stored in the memory 104 of the location correlation server 110, as shown and described with reference to FIG. 1.

At 310, an indication of a location event including, for example, lat-long coordinates, can be received. For example with reference to FIG. 1, first compute device 130 and/or the second compute device 140 can send a signal including geo location data, which can be received by the location correlation server 110.

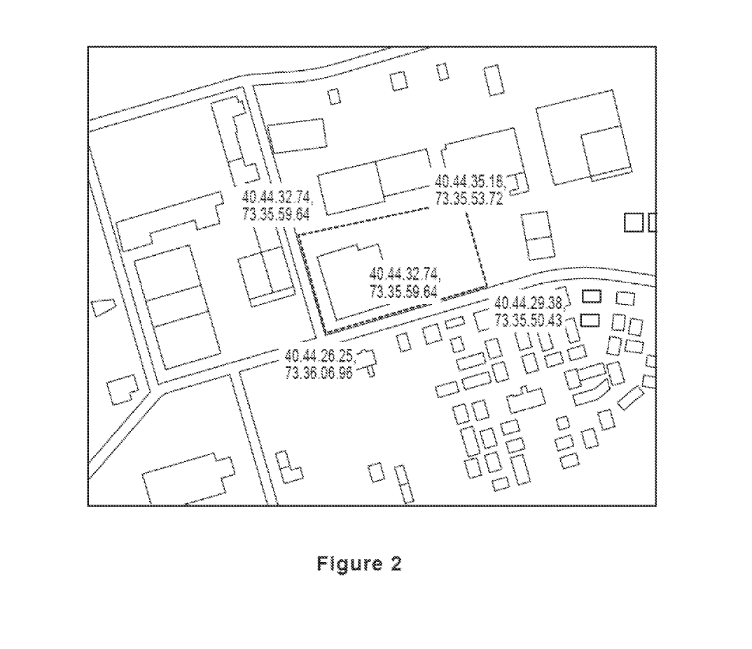

At 320, the location correlation server 110 can search a Geo Relevance store 325 (which can be structurally and/or functionally similar to the database 120) for matching and/or nearby entries (e.g., within 100 feet, within 500 feet, within ⅛ mile, or any other suitable range). Similarly stated, the Geo Relevance store 325 can be searched, at 320, for records of other computing devices having been at, near, or otherwise associated with the location associated with the location event received at 310. Geo Relevance store 325 entries can associate a physical location with a brand. For example, a match can indicate that the mobile device is in and/or near a retail location associated with a brand. In other embodiments, a polygon method can be used to determine if the geo location data matches an entry in the Geo Relevance store 325. For example, FIG. 2 shows the example of specific lat-long coordinates 220 within a polygon 225 related to a retail store. Any lat-long coordinates within this polygon 225 can qualify as matching the retail location. The Geo Relevance database 325 can store records relating auxiliary information to the lat-long or polygon coordinates that may be used in later modeling processes. In some instances, the location correlation server 110 can receive hashed location data, at 320. In such an instance, searching the Geo Relevance store 325 can include determining whether the Geo Relevance store 325 includes a matching hash.

If, at 330, the lat-long coordinates are not associated with a point-of-interest in the Geo Relevance database, at 335, the lat-long coordinates can be stored in a queuing process, which, when prompted, can search third-party services for information associated with the lat-long coordinates. For example, a third-party mapping service can be searched to determine if the lat-long coordinates are associated with a retail establishment, point-of-interest, or any other suitable identifiable geographic feature. If a third party service returns auxiliary data regarding the lat-long coordinates received at 310, the Geo Relevance database 325 can be updated with the lat-long coordinate and third-party auxiliary data.

Optionally, if, at 330, the lat-long coordinates received at 310 are present in the Geo Relevance store 325, the received lat-long coordinates are hashed, at 340, generating a locationID and masking the received literal (or raw) coordinates. The hashing enables a history of the mobile device's geo location activity to be stored in a way that enhances the privacy of the mobile user. The hashing can include applying a one-way hash such that the original lat-long coordinates are not retrievable. The combination of an identifier associated with the mobile device (e.g., a deviceID) and locationID can then used to update the Geo History store 345. The Geo History store 345 can include geo location history and/or path history of one or more mobile devices. In some embodiments, the geo history store 345 can be updated with a literal (e.g., unhashed), non-anonymized location identifier. In other words, in some embodiments the hashing can be optional where the user information need not be anonymized.

At 350, a Commercial Action store 355 can be searched to determine if the mobile device has taken a Commercial Action, such as visiting a retail store associated with a marketer. If, at 357, locationID does not match an entry in the Commercial Action store 355, the method can terminate, at 359. If, however, at 355, the locationID associated with the mobile device matches an entry in the Commercial Action store 355, the mobile device can be associated with a Commercial Action. If the mobile device is associated with a Commercial Action, at 360, data associated with the Commercial Action can be stored in a Commercial Action History store 365, which can include a history of one or more mobile devices' relevant marketer-related actions.

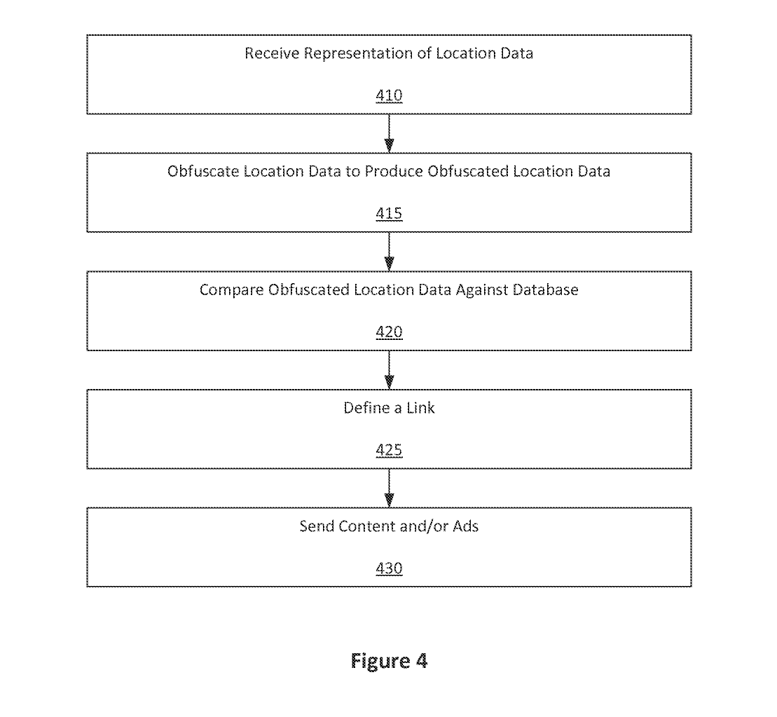

FIG. 4 depicts a method for associating compute devices based on location data. The method of FIG. 4 can, in some embodiments, be executed by the location correlation server 110 (e.g., on the processor 102) and/or embodied as instructions stored in the memory 104 of the location correlation server 110, as shown and described with reference to FIG. 1. At 410, a representation of location data (e.g., geo location data) can be received from, for example, the first compute device 130. The geo location data can include a record of one location, for example, sent in response to invoking an app or accessing a webpage, or can include a record of multiple locations, for example recorded over a period of time. In some embodiments, the representation of location data can include lat-long data captured by the location module 136. In other embodiments, the representation of location data can include cell-tower location data, signal strength data, an IP address, and/or any other suitable data that can be correlated to location.

The location data can be obfuscated, at 415, for example, by applying a one-way hash to the location data. The location data can be optionally truncated before being obfuscated. For example, trailing digits of lat-long coordinates can be dropped and/or rounded before applying a hash such that the same hash result will be returned for any location data within an area associated with the degree of truncation applied. For example, if the geo location data received, at 410, indicates that the first compute device was located at 40.78337° N, 73.96672° W, these data indicate a position within less than 7 square feet. If these raw data are hashed, the resulting hash will continue to be uniquely associated with the same 7 square foot area, but that 7 square foot area will be stripped of all geographical context. Accordingly it may only be possible to meaningfully matched that hash of that raw data to other hashed location data corresponding to the same 7 square foot area. In some embodiments, it may be desirable for the hash to correspond to a larger area. Accordingly, in some embodiments the raw location data can be rounded or truncated to four decimal digits, which would uniquely identify an area of less than 700 square feet, to three decimal digits, which would uniquely identify an area of less than 70,000 square feet, or any other suitable level of truncation. In this way, after truncated location data are hashed, the hash of the data can be meaningfully matched to other data that is associated with larger areas, such that, for example, two users who have visited the same store or block can be associated, rather than only associating users have been within about 3 feet of each other.

In some embodiments, the location data can be further anonymized, for example, by being stripped of personally identifiable information, such as a phone number, unique user ID, etc. In some such embodiments, a new identifier uniquely associated with the compute device but otherwise not associated with personal information such as a serial number or a hash of a personally identifiable information, can be assigned to or associated with the location data in a database (e.g., the database 120) such that other instances of location data associated with the compute device can be identified.

At 420, the obfuscated location data can be compared against a database. The database can contain, for example, records associating hashed locations to brands, points of interest, and/or other compute devices (e.g., the second compute device 140). For example, in some instances, comparing the obfuscated location data associated with the first compute device against the database at 420 can produce a match to a record indicative of the second compute device having been in the same location. In some embodiments, the second compute device may be anonymized such that a link may not reveal personal information associated with the user of the second compute device.

In some instances, comparing the obfuscated location data associated with the first compute device against the database at 420 can produce a match to a record indicating that the first compute device was at a location associated with a brand or other point of interest. For example, the database can include a record that the brand “Starbucks®” is associated with multiple obfuscated locations such that the match can indicate that the first compute device was at a Starbucks® location without indicating any specific Starbucks® location.

The location data received, at 410, and/or the obfuscated location data produced, at 415, can optionally be stored in the database. Similarly stated, one or more records can be defined in the database associating the first compute device with the location and/or obfuscated location data. Alternatively, the location data received, at 410, may not be stored in a memory or database after being obfuscated, at 415. Similarly stated, the location data received at 410 can be deleted or otherwise not retained after the data is obfuscated, at 415. Similarly, in some embodiments, the obfuscated location data may be deleted after it is compared against the database, at 420. Alternatively, new records can be defined in the database associating the first compute device to the obfuscated location. Similarly, in embodiments in which data representing more than one location is received, at 410, a database entry can be defined for each obfuscated location. In some instances, database entries may be defined only for obfuscated location data that matches an existing obfuscated location.

At 425, a link can be defined between the first compute device and the second compute device and/or a brand based on the database comparison. The link can be used to associate the first compute device to the second compute device and/or the brand such that content and/or advertisements can be served to the first compute device and/or the second compute device based on the association. For example, the method can be operable to associate the first compute device with a Starbucks® location and/or a second compute device. Then, at 430, content and/or advertisements can be served to the second compute device and/or the first compute device based on the association such that, for example, the second compute device receives content and/or advertisements based on the first compute device having visited a Starbucks® location. In embodiments where the first compute device and/or the second compute device are anonymized (e.g., stored in the database without identifying information), the link defined at 425 can allow content to be served to the second compute device without further information about the first compute device, such as the owner of the first compute device, demographics associated with the first compute device, browsing history, etc.

As described in further detail herein, in some embodiments, location data and/or obfuscated location data can be used to develop models of user behavior, for example, commuting patterns, frequently visited locations, etc. can be determined based on the location data and/or obfuscated data. Models built with obfuscated location data may maintain privacy of user data, but may nonetheless provide useful information regarding patterns of activity. For example, if two compute devices regularly visit at a common location those devices may be linked even if that location is obfuscated. Furthermore, if one of those two devices visits a location associated with a brand (or frequently visits a location associated with a brand), it may be useful to link the other compute device with the brand, even if the location that originally caused the link to be defined and the location associated with the brand are obfuscated. In some embodiments, building such a model can include determining the frequency at which a compute device is present at an obfuscated location and/or discarding obfuscated locations that are not visited more than a threshold number of times, which can, for example, eliminate insignificant locations, eliminate locations transited through and/or can provide dimensionality reduction to simplify the constructed models.

Although various embodiments described herein discuss a first compute device and a second compute device, it should be understood that this is for illustrative purposes only. Similarly stated, other embodiments can include any number of compute devices. For example, some embodiments describe linking, relating, or otherwise associating two compute devices, it should be understood that three, five, ten twenty, or any number of compute devices can be linked as described in those embodiments. Furthermore, where linking, relating, or associating two compute devices are described, it should be understood that these two compute devices may not be pre-selected. Similarly stated, a first compute device can be selected from a group of compute devices as a match for a second compute device selected from the same group of compute devices or a different group of compute devices based on a statistical model, neural network, supervised or unsupervised learning technique, or any other suitable method.

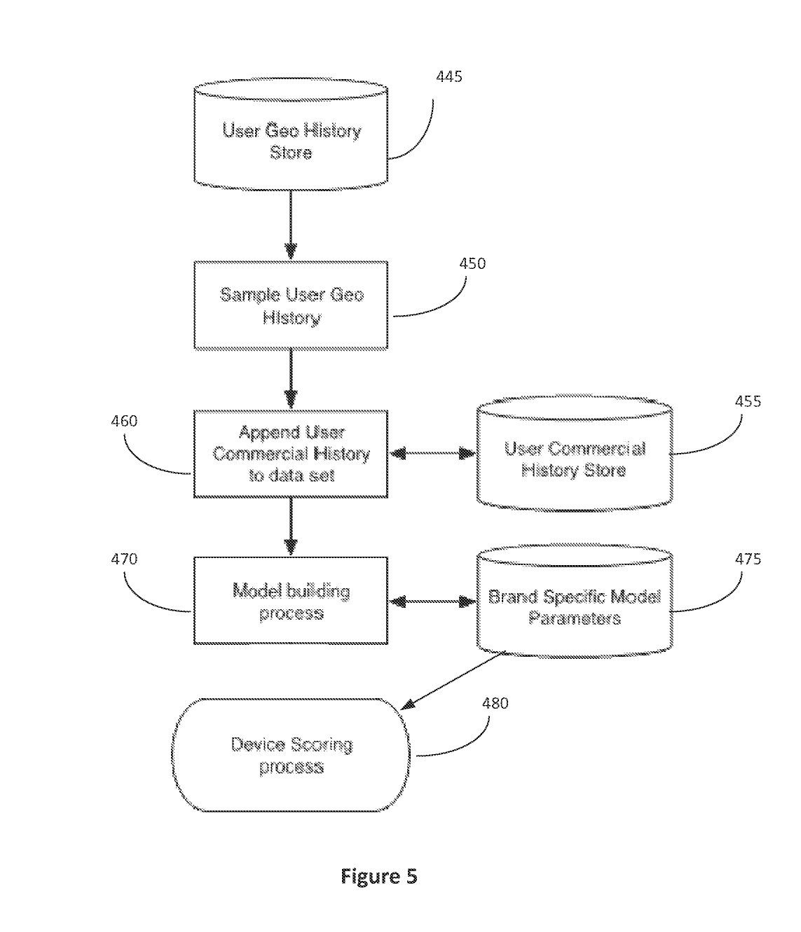

FIG. 5 shows a process for building predictive models using data from mobile geo location history and Commercial Actions, according to an embodiment. A supervised statistical model can be generated to relate, for example, the Geo History store to relevant Commercial Actions (recorded in the Commercial History store). An example modeling procedure might be as follows:

a. at 450, pull a random sample of user geo location histories from the Geo History store 445;

b. at 460, identify users in the Commercial History Store 455 that have been to a given marketer's store locations; and

c. use the set of users identified in (b) to augment the set in (a) with a dependent target variable, which is set to 1 if the user is in (b), and 0 otherwise.

At 470, supervised learning techniques such as logistic regression, can be used to train a model to predict user relevance as a function of the locationIDs in the user's history. In some embodiments, brand specific model parameters 475 can be used to stabilize or initiate the model building process, at 470.

The brand-specific model parameters 475 can be an output of the modeling process 470 and can include a set of weights or a learned statistical function associated with the brand that can map the user's history of locationIDs to a score that measures the user's relevance to the brand or task at hand. In addition or alternatively, brand specific model parameters 475, such as correlations between the brand and other brands and/or Commercial Actions can be used as an input to the model building process 470, for example, the model can be developed, at 470, with feedback from previously developed models.

The brand-specific model parameters 475 can be used for a device scoring process 480, which can include a Geo Prospect Rank for each deviceID calculated for each marketer and stored in a Geo Prospect Rank store (not shown) for future use by an advertisement optimization server. Similarly stated, the device scoring process 480 can be used to select advertisements for a user.

Although the geo history store 445 and/or marketer locations are described as inputs to the model building process 470, in other embodiments any suitable inputs can be used to determine whether any suitable Commercial Action has been performed. For example, data associated with a mobile device such as, for example, web purchase history, in-app purchase history, or downloaded app history can be used to predict any suitable Commercial Action, such as visiting a retail location, making future web-based or in-app purchases, downloading additional apps, visiting brand-related websites, etc.

### Example Applications

### Location Retargeting

Location Retargeting can refer to targeting advertisements associated with a location to a person who has previously visited the location. For example, Location Retargeting can involve selecting targeted advertisements based on matching a deviceID to a database of compute devices previously determined to be relevant to the brand or marketer. In some embodiments Location Retargeting can include evaluation of other compute devices. For example, a Commercial History store can be queried to identify Commercial Actions commonly associated with the location of the compute device. For example, if compute devices in a train station have a high incidence of coffee purchases, an advertisement for a coffee chain can be served to a compute device located at or near a train station. In some such embodiments, the Commercial Action may not be directly associated with the location. In other words, a train station can be associated with coffee even if there are no coffee shops in the train station. Such an association can be based on an aggregate of the history multiple users' compute devices.

At the time of data transmission via the bid request, a Commercial History store can be queried with the deviceID associated with the bid request. If a positive match is returned, the query can return all brands previously deemed relevant to the compute device. These brands can then be passed to an advertising optimization server, which can select a final advertisement and bid price to be transmitted to an advertising exchange. This same approach can be used to target people who have been in a broad category of locations, e.g., targeting Starbucks® advertisements to anyone who has been in a coffee house or target travel advertisements to people who have been in an airport.

As discussed herein, in some embodiments Location Retargeting can employ obfuscated location data, such that the deviceID may be matched to brands and/or to other compute devices relevant to the brand or marketer based on an on a hash of location data associated with the brand and/or other compute devices.

### Audience Identification Using Location Based Models

Targeting by Location Based Models is a method for incorporating the Geo Prospect Ranks, which can be, for example, the output of the compute device scoring process 480 as shown and described with reference to FIG. 5, to determine the optimal advertisement to target at a user. The deviceID of the user's compute device can be matched to the Geo Prospect Rank store, which can return scores for active campaigns. A marketer advertisement selection module can identify campaigns that meets the targeting criteria, select a final advertisement, and/or bid price to be transmitted back to an advertisement exchange based on the brand relevance scores passed to it.

Similarly stated, in some embodiments, predictive models built based on, for example, geo location history and/or Commercial Actions can be used to select advertisements and/or content to be presented to a particular user's compute device. For example, a model can be used to draw associations between a compute device and a location based on the compute device having visited that location, based on the compute device being associated with another compute device that has visited that location, based on the compute device being associated with a brand that is associated with that location, etc. Then, the Geo Prospect Rank store can be used to identify one or more advertising campaigns associated with that location and a score for that location and each of the one or more advertising campaign. Content sent to the compute device can be based on the score (e.g., if an advertising campaign is highly scored for the location, advertisements associated with that advertising campaign can be served to the compute device). In this way, Targeting by Location Based Models can be used to identify which content or advertisements to provide to the compute device based on a campaign score for that location. Thus, Targeting by Location Based Models can provide content that is tailored to the user of the compute device based on activities, patterns of behavior, interests, etc. of other users who have been to the same location or are otherwise linked to the compute device. Such tailored content may be of greater interest to the user, provide greater value to advertisers, and so forth.

### Brandscaping

It is further possible to use the events recorded in the Commercial History store, Geo Prospect Rank store, and/or a Prospect Rank score (a Prospect Rank score can be, for example, an indication of a user's or “Prospect's” likelihood of engaging in a Commercial Action) to score points-of-interest according the density of compute devices with relevant commercial history or high scoring Prospects for a particular marketer. In some embodiments, this information can be used to aid marketers in targeting specific geographic regions for advertising. In other embodiments, this information can be used to target advertising to a user when the user is traveling away from home.

In some embodiments, if one compute device is frequently (e.g., at least three times within a month, at least twice within a week, at least five times within a week, etc.) located in the vicinity (e.g., within 10 feet, within 100 feet, within 250 feet, etc.) of another compute device (e.g., a mobile device and/or a stationary device such as a PC), the compute devices can be associated or “clustered” (e.g., by the advertising optimizing server 130 as shown and described above with reference to FIG. 1). A Prospect Rank score can be associated with the cluster and/or the cluster can share a common Prospect Rank score. For example, a user may carry a mobile device and have a PC at home. The advertising optimizing server may receive indications associated with the location of the mobile device and/or the PC, (such as lat-long data, IP address, street address, cell-tower data, etc.) and can thereby determine that the mobile device and the PC are clustered. In such an example, historical browsing behavior on the PC can be used to select advertisements for the mobile device. Similarly, historical user activity on the mobile device and/or historical location information of the mobile device can be used to select advertisements for the PC. As one example, Location Retargeting data can be associated with the cluster, such that targeted advertisements can be selected for one compute device of the cluster based on matching a deviceID of another compute device of the cluster to a database of compute devices previously determined to be relevant to the brand or marketer.

In some embodiments, a Brandscape can be a visual representation of an average (or other statistical representation) of the Prospect Rank scores for multiple users within a geographic region. For example, as described in further detail herein, user activity associated with a brand can be captured and/or aggregated from multiple users' compute devices within a geographical region. Statistical techniques can be applied to correlate brand affinity to location data such that the brand affinity can be visualized on, for example, a geographic map.

In some embodiments, each user's compute device can be associated with a “home” region, a secondary region, a tertiary region and so forth. For example, the home region of a mobile device can be a geographic area where the mobile device is most frequently located. In some embodiments, the affinity of a brand in a particular geographic region can be calculated based on compute devices (e.g., mobile devices, PCs, televisions, etc.) that are “at home” in that geographic region but not based on compute devices that are identified as having a “home” in other geographic regions. In other embodiments, the affinity of a brand for a region can factor how frequently each compute device is located within that region.

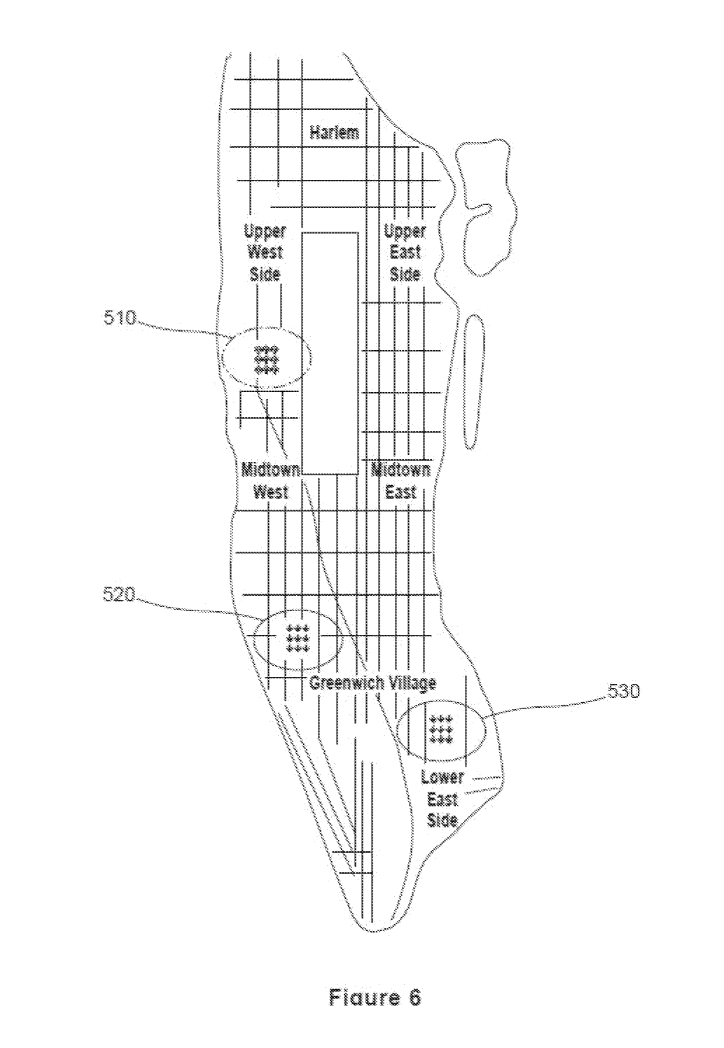

For example, as shown in FIG. 6, a brand may have a high affinity 510 in the Upper West Side and a low affinity in Chelsea 520 and the West Village 530. For example, the brand might be a luxury good that is targeted to older and/or wealthier customers. This data can relate specific locations, for example, buildings, neighborhoods, and/or census blocks, to the brand. In some embodiments, advertisements can be sent to a mobile device based on the Geo-History of the mobile device and/or the affinity for the brand in the area in which the mobile device is located. The region of high affinity 510 can be a hot spot (i.e., geographic region with a relatively high rate or count of Commercial Actions (e.g., web visits, app usage, physical location purchases, etc.)) associated with the brand.

For example, a user having a clustered PC and a mobile device living in Stamford, Connecticut, may frequently visit a coffee chain website while at home, which may result in the cluster having a high Prospect Rank score for the coffee chain. If the user's mobile device is frequently located in the Upper West Side, the user's mobile device can contribute to the high brand affinity 510 for that geographic region. Based on the high brand affinity 510 of the geographic region, advertisements associated with the brand can be selected for, for example, other mobile device users in the region of high brand affinity 510.

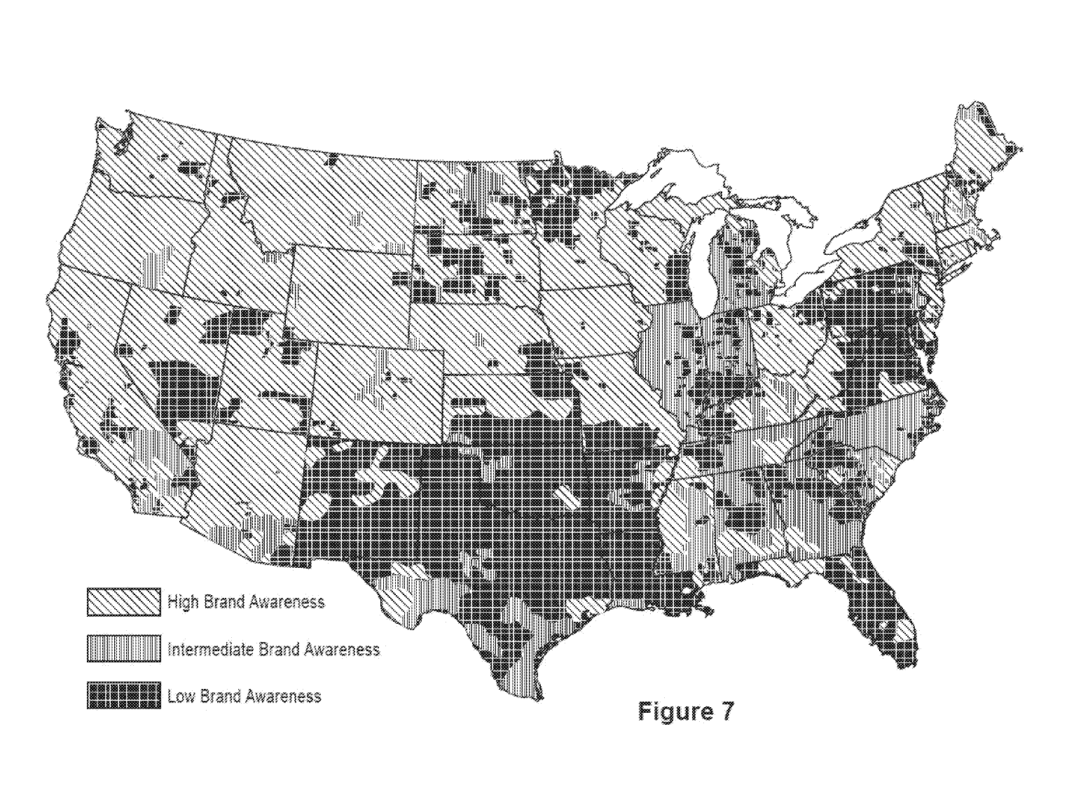

As another example, FIG. 7 depicts brand awareness (a “brandscape”) of a first brand. Awareness of the first brand is high in the Northwest and Southwest, weak in the South-Central region, and there is intermediate brand awareness in North-Central region. Based on this information, a marketer associated with this brand might send an advertisement to a traveler from Texas who is present in Oregon. In this way, the marketer may be able to inform the traveler of a locally strong brand with which traveler may not have been familiar.

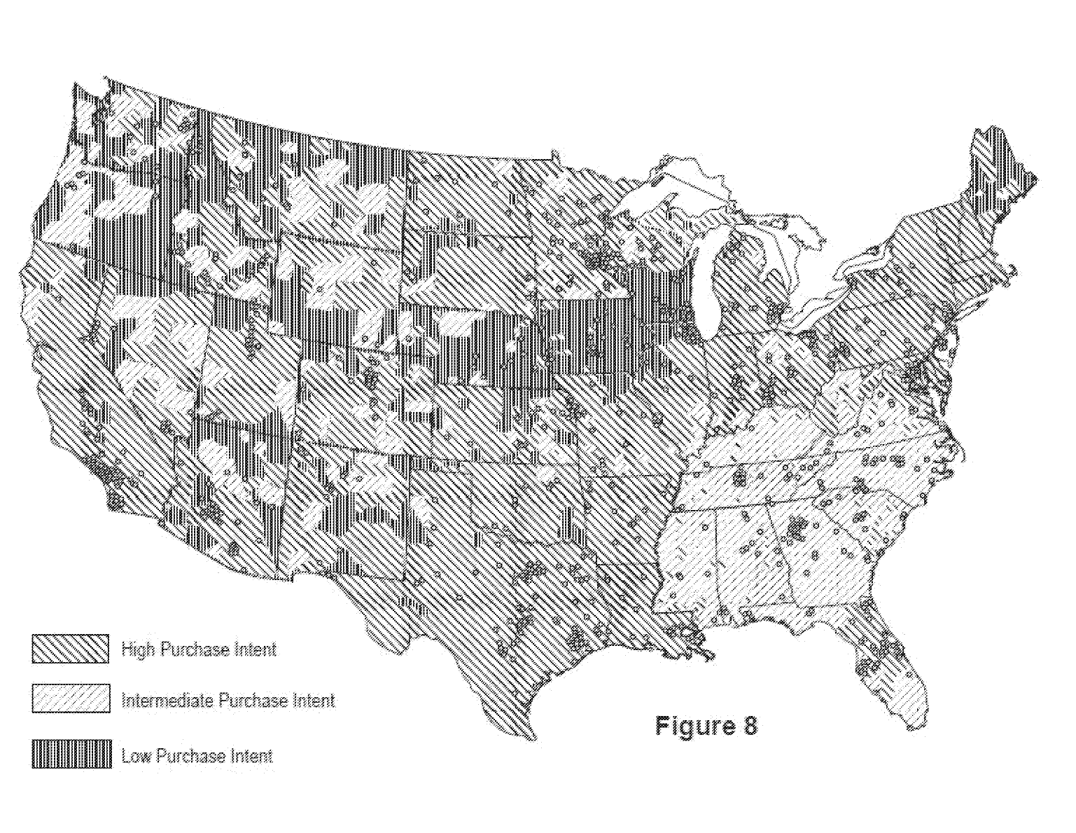

As another example, FIG. 8 depicts brand awareness and purchase intent associated with a second brand. Retail locations are indicated as circles in FIG. 8. FIG. 8 shows that regions with high concentrations of stores tend to have higher brand awareness.

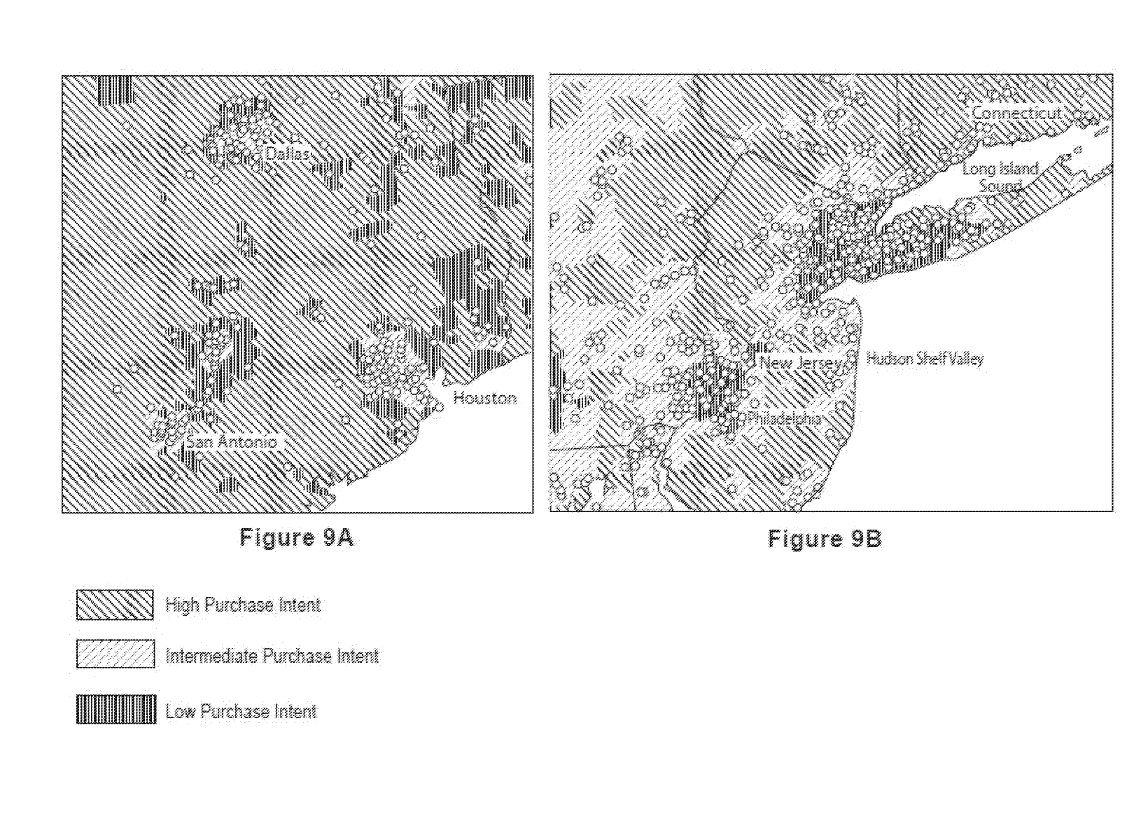

FIGS. 9A and 9B are detailed views of FIG. 8 centered on the Texas Triangle and the Northeast Corridor, respectively. FIGS. 9A and 9B show that while stores are clustered in urban areas, higher awareness of the brand is associated with lower density areas. Based on these data, the marketer associated with the second brand might conclude that a high concentration of retail locations cannibalizes web activity (on which brand awareness scores are based). The marketer might choose to engage in an advertising campaign intended to drive urban customers to the website (e.g., by offering web-only discounts) in order to raise brand awareness. Alternatively, the brand owner might launch new retail stores in locations with high brand awareness, which may be indicative of pent up demand.

In some embodiments data associated with a brandscape may inform traditional (i.e., non-Internet) advertising. For example, using a brandscape, a marketer may identify addresses, telephone numbers and/or cable and/or satellite subscription regions for targeted advertising (e.g., web-based and/or traditional advertising).

While various embodiments have been described above, it should be understood that they have been presented by way of example only, and not limitation. Where methods described above indicate certain events occurring in certain order, the ordering of certain events may be modified. Additionally, certain of the events may be performed repeatedly, concurrently in a parallel process when possible, as well as performed sequentially as described above. Although various embodiments have been described as having particular features and/or combinations of components, other embodiments are possible having a combination of any features and/or components from any of embodiments where appropriate as well as additional features and/or components.

For example, although some embodiments describe “hashing” an identifier or other data, in other embodiments other anonymization techniques can be used such as other cryptographic one-way functions. As another example, although some embodiments describe “lat-long” data, any suitable location data or location proxy can be used, such as IP address, cell tower data, geo-fence data, etc.

As another example, although some embodiments describe linking or associating two compute devices, it should be understood that any number of compute devices can be linked or associated by similar means. Furthermore, some embodiments relate to linking or associating multiple compute devices, while other embodiments relate to linking or associating a compute device and a brand or point of interest. It should be understood that, in some embodiments, one compute device can be linked to one or more other compute devices and one or more brands. Similarly, one compute device can be linked to a brand based on that compute device being linked to another compute device that is linked to a brand. When a compute device is linked to multiple compute devices and/or multiple brands, any of the associated compute devices can receive content based on any of the links with any compute devices and/or brands. When such multiple links are defined based on obfuscated location data, in some instances, the links may not reveal personal data of any compute devices.

Some embodiments described herein relate to using location data to model interactions between multiple compute devices to, for example, determine links and/or associations between two or more compute devices. In some embodiments, a Geo History Store can include location data (e.g., lat-long data, IP address, etc.) identifying multiple locations where a first compute device and a second compute device have been present. The location data can be stored in an obfuscated or unobfuscated state. Each device can be represented by a location vector representing the multiple locations. The first compute device and the second compute device can be linked if model indicates a similarity between the location vector associated with the first compute device and the location vector associated with the second compute device. In addition or alternatively, the first compute device can be associated with the second compute device if a vector similarity function and/or one or more vector similarity metrics, return a value indicating a similarity between the two location vectors greater than a predetermined and/or configurable threshold. In addition or alternatively, a bipartite graph or other suitable modeling technique can be used to determine similarity between compute devices and/or location vectors.

Some embodiments described herein refer to obtaining and/or associating geographic data with Commercial Actions. It should be understood that a Commercial Action can include performing an action a marketer may desire a user to take in person or online. For example, visiting a physical retail store, purchasing a good or service at a physical retail store, directing a browser to a web presence associated with the marketer, making an online purchase, etc. can be Commercial Actions. Such Commercial Actions can be associated with the geographical location at which the Commercial Action physically occurred (e.g., the physical retail location and/or the physical location of the user's compute device) and/or any other suitable location associated with marketer and/or the user such as, the nearest physical retail location to a user taking an online Commercial Action, the home region of the user's compute device, etc.

Some embodiments described herein relate to computer-readable medium. A computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes including for example some or all of the processes and methods described above. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as ASICs, PLDs, ROM and RAM devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

1. A non-transitory processor readable medium storing code representing instructions to be executed by a processor, the code comprising code to cause the processor to:
receive, from a first compute device, a signal including a representation of location data for the first compute device;
modify the representation of location data to produce a first obfuscated identifier such that the location data cannot be determined based solely on the first obfuscated identifier;
compare the first obfuscated identifier against a database of obfuscated identifiers, each obfuscated identifier from the database of obfuscated identifiers associated with a location that cannot be determined based solely on that obfuscated identifier; and
define a link between the first compute device and a second compute device based on the first obfuscated identifier matching a second obfuscated identifier, the second obfuscated identifier being from the database of obfuscated identifiers, the database including a record of the second compute device being at a location associated with the second obfuscated identifier, the link defined such that the second compute device can receive content based, at least in part on the link between the first compute device and the second compute device.

2. The non-transitory processor readable medium of claim 1, the code further comprising code to cause the processor to:
receive, from the first compute device a plurality of signals including representations of location data, the signal being from the plurality of signals;
modify the representations of location data to produce obfuscated identifiers associated with a plurality of locations associated with the first compute device such that the plurality of locations cannot be determined based solely on the plurality of obfuscated identifiers, the first obfuscated identifier being from the plurality of obfuscated identifiers;
compare the plurality of obfuscated identifiers against the database of obfuscated identifiers; and
delete a subset of the plurality of obfuscated identifiers from the plurality of obfuscated identifiers based, at least in part, on the subset of the plurality of obfuscated identifiers not matching an obfuscated identifier from the database of obfuscated identifiers.

3. The non-transitory processor readable medium of claim 2, wherein the code to cause the processor to delete the subset of the plurality of obfuscated identifiers includes code to cause the processor to delete the subset of the plurality of obfuscated identifiers based, at least in part, on each obfuscated identifier from the subset of the plurality of obfuscated identifiers appearing in the plurality of obfuscated identifiers less than a threshold number of times.

4. The non-transitory processor readable medium of claim 1, the code further comprising code to cause the processor to:
compare the first obfuscated identifier against a list of points of interests, a point of interest from the list of points of interests being associated with a third obfuscated identifier; and
define a link between the point of interest and the first compute device based on the first obfuscated identifier corresponding to the third obfuscated identifier, such that the second compute device can receive content based, at least in part, on the link between the point of interest and the first compute device.

5. The non-transitory processor readable medium of claim 4, wherein:
a plurality of locations is associated with the point of interest; and
the code to cause the processor to define the link between the point of interest and the first compute device includes code to cause the processor to link the point of interest and the first compute device without defining a link between the first compute device with any location from the plurality of locations.

6. The non-transitory processor readable medium of claim 1, the code further comprising code to cause the processor to:
assign a user identifier to the first compute device before defining the first obfuscated identifier such that a personal identity of a user associated with the first compute device cannot be determined based solely on the user identifier; and
the link between the first compute device and the second compute device being based on the first obfuscated identifier and the user identifier such that the personal identity of the user associated with first compute device, a personal identity of a user of the second compute device, and the location associated with the first obfuscated identifier cannot be determined based solely on the link between the first compute device and the second compute device.

7. The non-transitory processor readable medium of claim 1, wherein the location data includes lat-long data, the code further comprising code to cause the processor to:
truncate the lat-long data before defining the first obfuscated identifier such that the first obfuscated identifier is associated with a geographic region having a size determined by a degree of truncation.

8. The non-transitory processor readable medium of claim 7, wherein each obfuscated identifier from the database of obfuscated identifiers is associated with a geographic region having the size determined by the degree of truncation.

9. The non-transitory processor readable medium of claim 1, the code further comprising code to cause the processor to send the content to the second compute device.

10. The non-transitory processor readable medium of claim 1, wherein the link between the first compute device and the second compute device represents a determination that the first compute device and the second compute device are operated by a common user.

11. The non-transitory processor readable medium of claim 1, the code further comprising code to cause the processor to define an entry in the database based on the first obfuscated identifier.

12. The non-transitory processor readable medium of claim 1, the code further comprising code to cause the processor to discard the location data after producing the first obfuscated identifier and before defining the link between the first compute device and the second compute device.

13.-22. (canceled)
